(19) United States
(12) Patent Application Publication
(10) Pub. No.: US 2007/0079347 A1
(43) Pub. Date: Apr. 5, 2007

(54) Method for content delivery without complicated viewers countermeasure and a system therefor

(75) Inventor: Tetsuo Makise, Tokyo (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/529,440

(22) Filed: Sep. 29, 2006

(30) Foreign Application Priority Data
Sep. 30, 2005 (JP) 2005-287776

(51) Int. Cl. H04N 7/173; H04N 7/16

(52) U.S. Cl. 725/115; 725/117; 725/118; 725/114; 725/145; 725/92

(57) ABSTRACT

A service delivery system includes a set-top box, a card reader and a monitor as a user terminal system. In the set-top box, a card reader unit reads out information from a card to store the information read out temporarily in a memory. An authenticator authenticates key information permitting contents delivery and time limit information both included in the stored information to generate an enable signal according to an authentication result indicating authenticity. Upon receiving the enable signal, a transmitter sends contents information included in the information read out as delivery request information to a delivery server. A contents receiver receives and decodes contents supplied from the delivery server. The delivery server receives the delivery request information and searches for contents corresponding to the delivery request information to deliver the contents to the user terminal system that has sent the delivery request information.

### BACKGROUND OF THE INVENTION

1. Field of the Invention

The present invention relates to a method for content delivery without complicated viewer's countermeasure and a system therefor, and especially to a method for delivering various contents including pictures, videos, musical data and applications to a user device constructing a home network according to the user's delivery request. The present invention also relates to a system for content delivery from a delivery server via a communications network to a user device constructing a home network with its configuration elements, for example, a personal computer, a home gateway, a set-top box and television receiver, etc.

2. Description of the Background Art

Generally, in a delivery system of contents, e.g. video etc., delivered from a content server to user's home gateway or set-top box, viewing is done according to the desired delivery of contents which is selected and requested from a program list by the viewer in advance. For example, known is an audio-visual information delivery system disclosed in Japanese patent laid-open publication No. 247647/1997.

In this prior art system, specific numbers are assigned to the contents that are stored in the content server to be delivered. Then, the viewer inputs the desired contents, i.e. the specific program number of the contents to a receiving terminal device by means of user interface such as a remote controller. While, the contents delivery service provider provides the list of programs to be delivered and their specific program numbers assigned to the contents and opens the list to the public by means of printed matter or electronic program guide EPG, in advance.

Thus, the viewer can input and/or select the number corresponding to his or her desired contents by means of remote controller, etc., based on the printed matter or the electronic program guide EPG displayed on the monitor connected to the receiving terminal device. According to the inputted or selected number, the content server delivers the requested contents to the set-top box (STB) for providing the contents to the viewer. In the case of pay contents, the viewer can view the contents by paying the charge in advance or by proceeding to pay the charge before viewing.

However, in this conventional system, any viewer who joins the content delivery service and has a set-top box can view the pay contents by paying charge. Therefore, it is difficult to deliver the special contents only to the specific viewer for viewing. For example, there may be such provision of service wherein a special service of promotion video of tunes composed by a certain musical artist only to the viewers who have bought the artist's tunes. In this case, it is desirable to let the specific viewers select the special video service, and, however, all service subscribers are able to know the provision of this special service as the contents information of the promotion video service is also described in the electronic program guide EPG.

It is possible to restrict the viewing by user authentication using a password. However, there might be the risk that such a password is broken. The counter measure against password breaking obliges the system to be considerably complex. Also, by means of user authentication using a password, the viewer needs to input his or her own password by using a remote controller which makes viewer's operation to be more complicated.

### SUMMARY OF THE INVENTION

It is an object of the present invention to provide a method for content delivery and a system therefor capable of requesting the delivery of contents provided for specified viewers and allowing them to easily view the contents without complicated viewer's operation and the introduction of a complex password countermeasure system.

A method of delivering contents according to the present invention comprises a first step of preparing a content server for delivering stored contents to a user terminal system provided with an access function to the content server, a second step of reading out stored information from a storage medium at the user terminal system, a third step of monitoring the status of the user terminal system according to the detection of the information read out, and determining whether or not the status is an operating status in which a picture is displayable, a fourth step of temporarily storing the information read out in the operating status of the user terminal system, a fifth step of reading out and authenticating key information included in the stored information, a sixth step of reading out and authenticating time limit information included in the stored information, a seventh step of generating, if the results from the authentication in the fifth and sixth steps are true, a packet to which delivery request information indicating the contents included in the stored information is added and then sending the generated packet to the delivery server, an eighth step of delivering the requested contents to the user terminal system which has sent the packet from the delivery server, and a ninth step of decoding the received contents into a signal based on a specific standard at the user terminal system.

In a content delivery system according to the present invention, wherein a content server delivers stored contents to a user terminal system provided with an access function to the content server, the user terminal system comprises a set-top box for determining whether or not the delivery of the contents which the delivery server provides is possible and notifying the result of the determination on whether or not the delivery is possible to the delivery server, and decoding received contents to output the decoded contents, a card reader for reading out information stored in a card-type storage medium and supplying the information to the set-top box, and a monitor for displaying the contents. In the content delivery system, the set-top box includes a reader interface circuit for reading out information from the card reader, a memory for temporarily storing the information read out, an authenticator for authenticating an identification key permitting delivery and delivery time limit information both included in the stored information to generate an enable signal according to the result of authentication indicating authenticity, a transmitter operative in response to the enable signal for sending contents information included in the read out information as delivery request information to the delivery server, and a receiver for receiving the contents supplied from the delivery server and decoding them. The delivery server receives the delivery request information and retrieves the contents corresponding to the delivery request information to deliver the contents to the user terminal system which has sent the delivery request information.

In accordance with the present invention, by reading out stored information from the storage medium at the user terminal system, observing the status of the user terminal system according to the detection of the information read out, and determining whether or not the status is the operating status in which a picture is displayable, temporarily storing the information read out in the operating status of the user terminal system, reading out and authenticating the key information included in the stored information, reading out and authenticating the time limit information included in the stored information, and generating, if both of the results of the authentication are true, a packet to which the delivery request information indicating the contents included in the stored information is added, sending the generated packet to the delivery server, delivering the requested contents to the user terminal system which has sent the packets from the delivery server, decoding the received contents into a signal based on a specified standard at the user terminal system, and outputting the decoded signal, and further by using the storing medium in which required information for the authentication of content delivery is stored in advance, it is possible to remove the complicated operation of a remote controller which would otherwise reference a printed matter or an electronic program guide EPG showing a program list provided for delivery to the viewer both supplied from a content delivery service provider, and deliver the contents only to the specific viewer. Furthermore, even when the operational mode of the receiver unit is the out-of-operation mode, the mode is automatically transited to the operating mode from the out-of-operation mode by requesting the content delivery by means of the storage medium.

### BRIEF DESCRIPTION OF THE DRAWINGS

The objects and features of the present invention will become more apparent from consideration of the following detailed description taken in conjunction with the accompanying drawings in which:

FIG. 1 is a block diagram showing a schematic configuration on an illustrative embodiment of a service delivery system to which applied is the system for content delivery according to the invention;

FIG. 2 is a block diagram showing schematic configuration on the user terminal system shown in FIG. 1;

FIG. 3 shows the schematic configuration of the IC card used in the user terminal system shown in FIG. 1;

FIG. 4 is a sequence chart useful for understanding an exemplified operational procedure of the service delivery system to which the invention is applied; and

FIG. 5 is a sequence chart useful for understanding another exemplified operational procedure of the service delivery system to which the invention is applied.

### DESCRIPTION OF THE PREFERRED EMBODIMENT

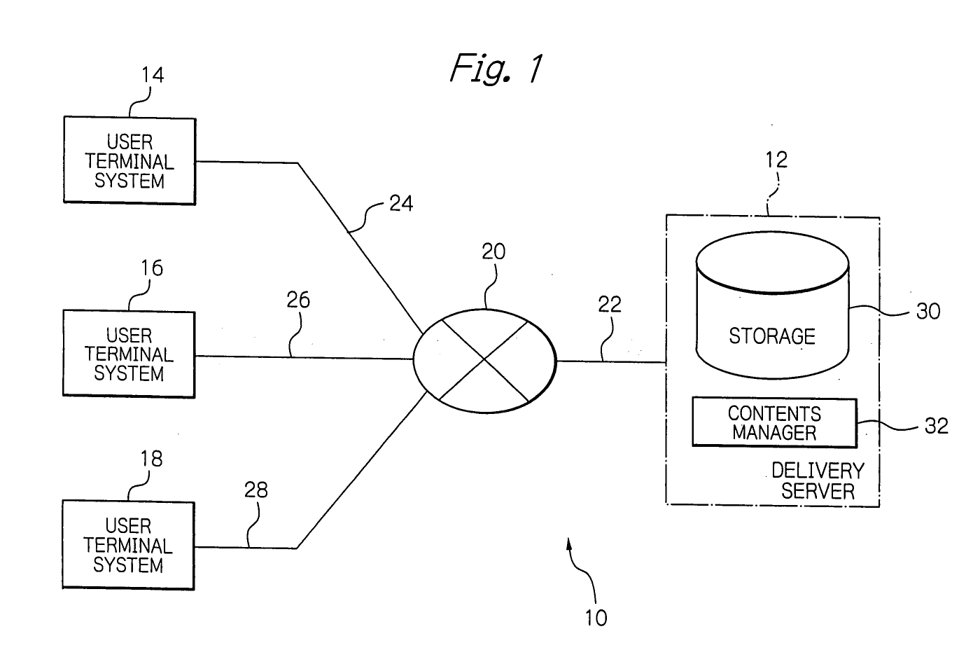

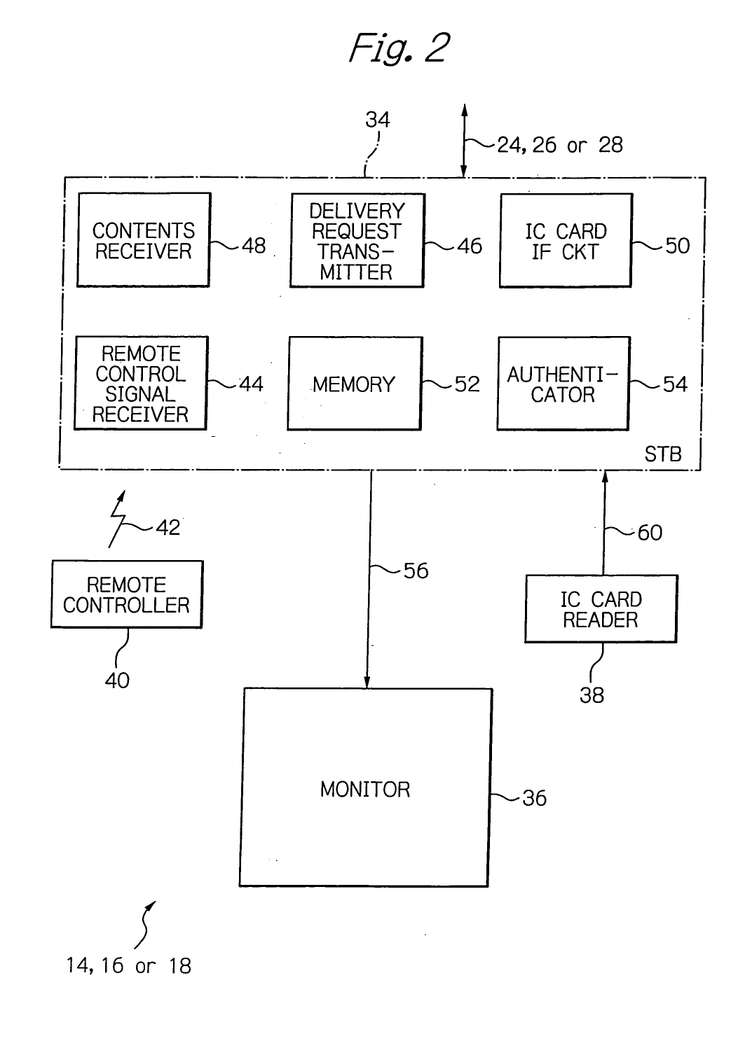

With reference to the accompanying drawings, an illustrative embodiment of the system for contents delivery according to the invention will be described in detail. Specifically referring first to FIGS. 1 and 2, the embodiment of the system for content delivery according to the invention includes plural user terminal systems 14, 16 and 18, each of which comprises a set-top box (STB) 34, an IC (Integrated Circuit) card reader 38 and a video monitor 36. The set-top box 34 serves as reading out information from the IC card reader 38 through its IC card interface circuit 50, storing the information read out temporarily in its memory 52, authenticating key information which permits delivery and time limit information both included in the stored information with its authenticator 54, and then generating an enable signal according to the authentication result indicating authenticity. The set-top box 34 includes a delivery request transmitter 46 serving as being responsive to the enable signal to send contents information included in the read out information as delivery request information to the delivery server 12, and a contents receiver 48 functioning as receiving contents supplied from the delivery server 12 and decoding them.

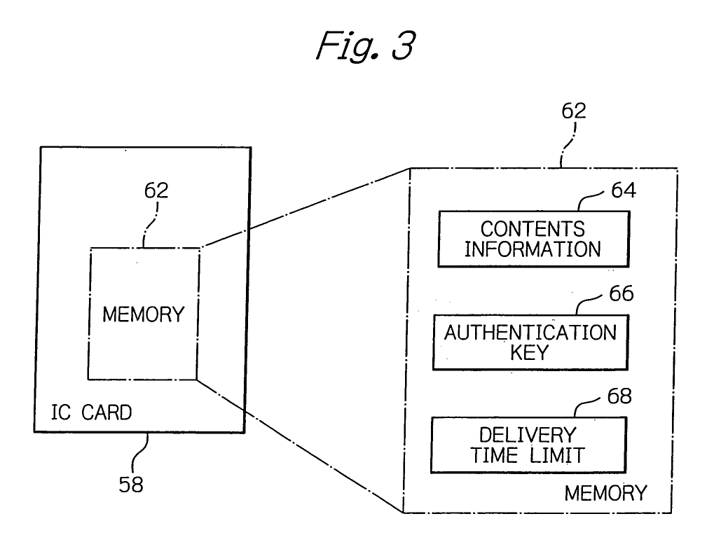

On the other hand, the delivery server 12 is adapted to receive the delivery request information and retrieve the contents corresponding to the delivery request information to deliver the contents to the user terminal system which has sent the delivery request information. Use is made of an IC card 58, FIG. 3, functioning as a storage medium in which required information for the authentication of contents delivery is stored in advance, and the required information is read out from the IC card 58, thus making it possible to remove the complicated operation which would otherwise be required on a remote controller while referencing a printed matter or an electronic program guide EPG showing a program list provided for delivery to viewers supplied from a content delivery service provider. Moreover, contents are delivered only to specific viewers and/or listeners. Furthermore, even though the operation mode of the receiver unit is out of service, the storage medium is used for requesting contents delivery to thereby render the operational mode of the receiver automatically to in-service or out-of-service mode.

The embodiment is directed to a service delivery system to which the present invention is applied. In the figures, part of the circuitry not directly relevant to the understanding of the present invention is not shown, and detailed description thereof will not be made in order to avoid redundancy. In the description below, signals are specified by the reference numerals of connections on which the signals are conveyed.

As shown in FIG. 1, the service delivery system 10 comprises the delivery server 12 and plural user terminal systems 14, 16 and 18. The configuration elements of the service delivery system 10 are connected to the network 20 over the connecting or transmission lines 24, 26, 28 and 38.

The delivery server 12 provides functions for storing plural contents, receiving delivery request information and delivering the contents corresponding to the delivery request information. The delivery server 12 is installed at the center facility of the content delivery service provider and is managed by the provider, for example. The contents may be pictures, videos, musical or audio data and applications, etc. The delivery server 12 comprises a storage 30 for storing contents and a contents manager 32 for deciding whether or not to provide services to the user who requests contents delivery. The delivery server 12 is connected to the network 20 over the connecting or transmission line 22.

Referring to FIG. 2, each of the user terminal systems 14, 16 and 18 is composed of the set-top box 34, monitor 36, IC card reader 38 and a remote controller 40.

The system configuration for the user terminal systems 14, 16 and 18 may be implemented by a personal computer having the functions of the set-top box 34.

For simplification of description, disclosure will be made only about the user terminal system 14, which may be the same in structure as the user terminal systems 16 and 18. Fundamentally, the set-top box 34 of the user terminal system 14 provides functions for receiving the delivery request information 42 sent from the remote controller 40, sending the received delivery request information 42 to the delivery server 12, receiving contents corresponding to the delivery request information 42 from the delivery server 12 and outputting the received contents to the monitor 36. Further, the set-top box 34 has a function of determining whether or not the user is qualified for receiving the content delivery service to authenticate if appropriate.

To realize above-mentioned functions, the set-top box 34 comprises the remote control signal receiver 44, delivery request transmitter 46, contents receiver 48, IC card reader interface (IF) circuit 50, memory 52 and authenticator 54. The set-top box 34 also has a system controller, not shown, which controls the configuration elements described above.

The remote control signal receiver 44 has a function of receiving a signal including the delivery request information 42 supplied from the remote controller 40. If the remote controller 40 has the infrared communication facility, the remote control signal receiver 44 is designed to provide the functions for receiving infrared rays and photoelectric conversion. The remote control signal receiver 44 transfers the received delivery request information 42 to the delivery request transmitter 46, not shown.

The delivery request transmitter 46 has a function of sending the delivery request information according to the result of authentication. The delivery request transmitter 46 assembles a packet including the supplied delivery request information 42 in response to the enable signal supplied from the authenticator 54, and sends the packet to which the required information is thus incorporated toward the delivery server 12. The delivery request information to be added may also be information indicating the operating mode.

The contents receiver 48 has functions of receiving the contents stream supplied from the delivery server 12 and of decoding the received contents stream to output the audio-visual signal 56 obtained from the decoded signal. The contents receiver 48 receives the contents stream supplied from the delivery server 12 over the signal line 24. The contents receiver 48 decodes and converts the received contents stream into the audio-visual (AV) signal 56. The contents receiver 44 then outputs the audio-visual signal 56 to the monitor 36 via its output terminal, not shown.

The IC card interface (IF) circuit 50 has a function of observing the status of the IC card reader 38 anytime and storing the information read out by the latter. The IC card IF circuit 50 has an interface function. As the interface function, one of the USB (Universal Serial Bus), use may be made of the IEEE (Institute of Electrical and Electronics Engineers) 1394, the RS (Recommended Standard) 232C or a dedicated interface. The IC card IF circuit 50 observes the status of the IC card reader 38 based on the information 60 obtained from the IC card 58, FIG. 3, inserted into the IC card reader 38. With the illustrative embodiment, the statuses to be observed are the operation modes of the set-top box 34, i.e. the operating status and the out of operation status. The IC card IF circuit 50 is provided with a function of transiting the operation mode of the set-top box 34 according to the result of observation.

The IC card 58 includes a memory 62. The memory 62 has the contents information 64, the authentication key 66 and the delivery time limit information 68 stored. The contents information 64 is the combination of the name of specific contents and storage information on the specific contents stored. The viewers can obtain the IC cards 58. For example, the IC cards 58 can be obtained as appendices of music tune CDs (Compact Disc) and magazines, etc., or bought directly at stores. In the FIG. 2 again, the IC card IF circuit 50 stores the information 60 read out by the IC card reader 38 into the memory 52.

The memory 52 has a function of storing information supplied and outputting the information according to a request. The memory 52 may store the information 60 read out, and supply the stored information 60 to the delivery request transmitter 46 and the authenticator 54 according to the request. In the embodiment, the memory 52 may be a RAM (Random Access Memory)

The authenticator 54 has a function of observing the status of the IC card reader 38 any time, and checking the information read out, i.e. an authentication key or private key. The authenticator 54 checks whether or not the authentication key is right. When the authentication key is checked as right, the authenticator 54 outputs the enable signal to the delivery request transmitter 46 for permission to send the delivery request information.

The monitor 36 has a function of display the audio-visual signal 56 supplied from the set-top box 34. The monitor 36 may be a television receiver. In the context throughout the specification, the word “monitor” should be comprehended broadly as a visual or audio monitor, and thence the word “viewer” be as covering a listener in addition to a viewer.

The IC card reader 34 has a function of reading out information included in the IC card 58 inserted therein and outputting the information read out. The IC card reader 38 is provided with the same interface function as provided for the IC card IF circuit 50. Therefore, the IC card reader 38 may have one of the interface functions, among USB, IEEE 1394, RS232C and its dedicated interface. As the IC card reader 38, a contact type reader or a non-contact type reader may be used in this embodiment. Besides, the IC card reader 38 may be integrated in the set-top box 34.

The remote controller 40 has a function of transmitting to the set-top box 34 the information entered on its input device such as a selector keys, ten-key, etc. In the case of infrared transmission, the remote controller 40 is designed to modulate an infrared carrier with inputted information and output the modulated signal toward the set-top box 34

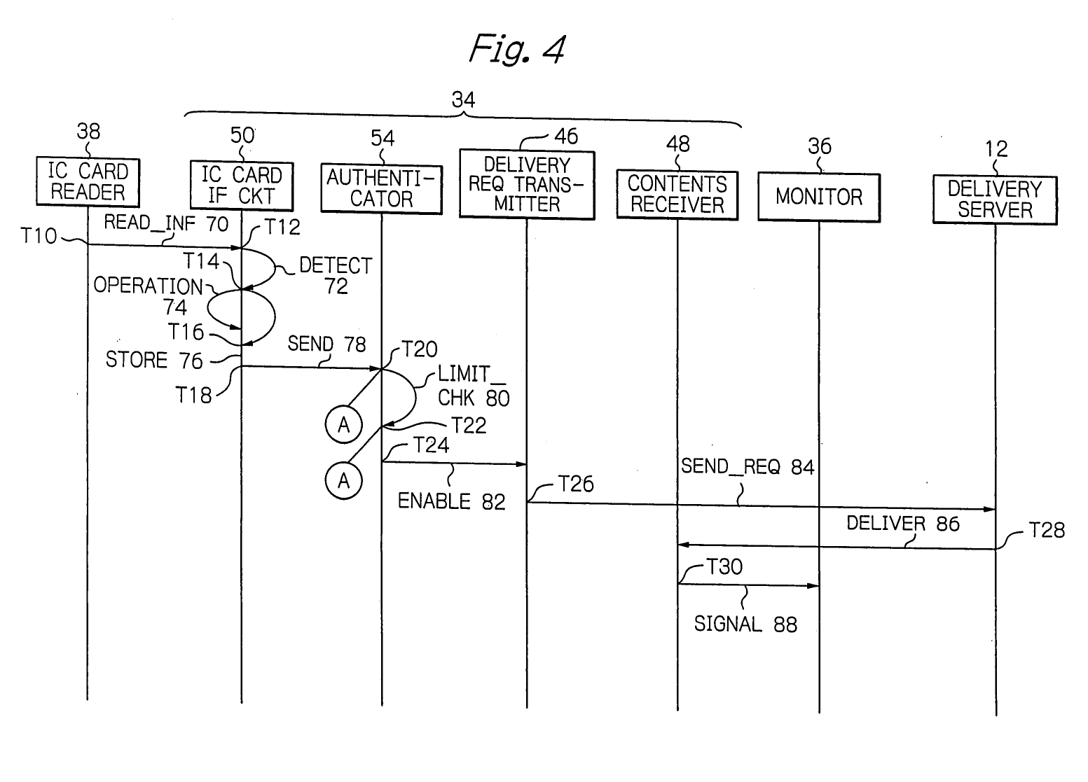

Next, referring to FIG. 4, a description will be made on the operational procedure of the embodiment of the service delivery system 10 to which the invention is applied. First, the viewer inserts his or her acquired IC card 58 into the IC card reader 38. The IC card reader 38 reads out information stored in the memory 62 of the IC card 58, and transfers the information 60 read out at the time T10 to the IC card IF circuit 50 of the set-top box 34 (READ_INF 70). The IC card IF circuit 50 detects the transferred information at the time T12 (DETECT 72). Usually, the set-top box 34 is in its waiting status. The waiting status means that the output function of video and audio signals is not active (off) though the power supply is switched on. At the waiting status, however, the IC card IF circuit 50 of the set-top box 34 is able to operate.

The IC card IF circuit 50 determines whether or not the status is the waiting status, at the time T14 (DETECT 72). If the waiting status is determined (YES), then the set-top box 34 transits the status to the operating status (OPERATE 76). In the operating status, the output function of the video and audio signals is active and the monitor 36 displays the electronic program guide EPG. If the waiting status is not determined (No), the set-top box 34 determines that the box 34 is in its operating status.

In the operating status, the set-top box 34 stores the supplied information 60 in the memory 52 temporarily, at the time T16 (STORE 76). Then, the memory 52 sends an authentication key included in the stored information 60 to the authenticator 54 (SEND 78). The authenticator 54 identifies the authentication key. When the authenticator 54 identifies the IC card 58 is authentic at the time T20 (YES), the unit identifies the delivery time limit (LIMIT_CHK 80). The identification of the delivery time limit is made by comparing the delivery time limit with a built-in clock. The clock is precisely calibrated by means of the network time protocol (NTP), for example. On the other hand, if the authenticator 54 identifies the IC card 58 is not authentic at the time T20 (No), then the set-top box 34 determines that the authentication key is not able to be read or the authentication key is not correct, and deletes the information 60 of the IC card 58 to terminate the delivery processing through the connector A in the figure.

When the authenticator 54 identifies that the delivery time limit of the IC card 58 is authentic at the time T22 (YES), the authenticator 54 generates the enable signal and sends it to the delivery request transmitter 46 at the time T24 (ENABLE 82). By contrast, if the authenticator 54 identifies the delivery time limit of the IC card 58 is not normal at the time T22 (NO), then the set-top box 34 deletes the information 60 of the IC card 58 and finishes the delivery processing through the connector A.

The delivery request transmitter 46 generates packets to which the delivery request information indicating the contents is added, and transmits the packets to the delivery server 12 at the time T26 (SEND_REQ 84). To transmit the packets, general-purpose protocol, either of the HTTP (Hyper Text Transfer Protocol) and the RTSP (Real Time Streaming Protocol) may be used.

The delivery server 12 delivers a contents stream associated with the received delivery request information to the set-top box 34 of the user terminal system 14 at the time T28 (DELIVER 86). To transmit the contents stream, either of HTTP and RTSP is also used. The contents receiver transmitter 48 receives the contents stream delivered to the set-top box 34 of the user terminal system 14. The contents receiver transmitter 48 decodes and converts the contents to the NTSC (National Television Standard Committee) format of audio-visual signal 56 and outputs the signal to the monitor 36 at the time T30 (SIGNAL 88). The monitor 36 visualizes the audio-visual signal 56 to display pictures and produces voices associated therewith.

The system operates as described above, so that, without displaying any electronic program guide EPG or manipulating any remote controller. It is therefore possible to read out and authenticate the information 60 of the IC card 58 via the IC card reader 38 connected to the set-top box 34 to send delivery request information to the delivery server 12, and receive the desired contents stream to display the contents on the monitor 36 at the user terminal system 14 having the IC card 58 mounted.

Next, an alternative embodiment of the service delivery system 10 will be described to which applied is the system for content delivery according to the invention. The structural elements of the embodiment may be the same as those of the aforementioned embodiment except that the authenticator of the alternative embodiment has a function of packetizing the information 60, the authentication key and delivery time limit information into IP (Internet Protocol) packets. In the delivery server 12, the contents manager 32 has the function of the corresponding authentication. With respect to implementation of these functions, the alternative embodiment is different from the aforementioned embodiment.

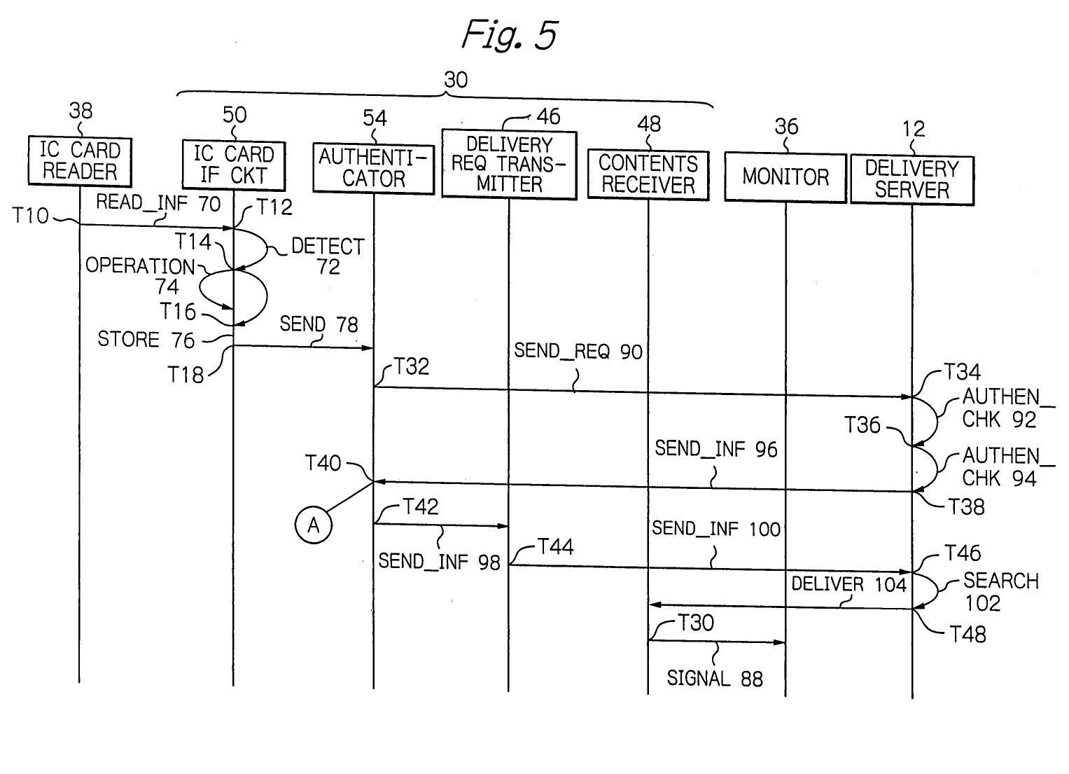

Referring now to FIG. 5, the operational procedure of the embodiment will be described. For simplification of the description, the description about the common procedure until the time T18 will not be repeated. The authenticator 54 packetizes the identification information comprising the information read out 60, the authentication key and delivery time limit information into IP packets. The authenticator 54 sends the IP packets including the identification information to the delivery server 12 at the time T32 (SEND_REQ90). It is preferable to use the HTTP on the SSL (Secure Socket Layer) for the packets to be sent. The SSL is the protocol used for transmitting and receiving encrypted information on the Internet.

The delivery server 12 checks the received packets as to whether or not identification information is included at the time T34. When identification information is included, the delivery server 12 extracts the identification information and authenticates the authentication key supplied to the contents manager 32 (AUTHEN_CHK 92). Next, the contents manager 32 authenticates the delivery time limit information at the time T36 (AUTHEN_CHK 94). If identification information is not included, the contents manager 32 decides not to deliver the contents. The delivery server 12 sends the information 96 corresponding to the result of the authentication to the set-top box 34 on the HTTP on the SSL procedure (SEND_INF 96).

The authenticator 54 determines whether or not the information 96 supplied thereto proves the accordance of the authentication at the time T40. When the information proves the accordance of the authentication, the authenticator 54 continues the delivery procedure. If the information proves disaccord of the authentication, then the authenticator 54 sends the information indicating the display of unauthorized delivery to the monitor 36, transits the operational mode of the set-top box 34 to its out-of-operation status, and finishes the delivery processing through the connector A.

When the delivery processing is continued, the authenticator 54 reads out contents information from the memory 52 and sends the contents information to the delivery request transmitter 46 (SEND_INF 98). The delivery request transmitter 46 sends the contents information supplied thereto in the form of delivery request information to the delivery server 12 at the time T44 (SEND_INF 100). The delivery request information 100 is sent based on the HTTP or RTSP.

The delivery server 12 searches for the contents corresponding to the delivery request information supplied thereto at the time T46 (SEARCH 94). The delivery server 12 delivers the corresponding contents stream to the set-top box 34 of the user terminal system 14 at the time T48 (DELIVER 104). The delivery server 12 transmits the contents stream, based on the HTTP or the RTSP. The contents receiver 48 receives the contents stream delivered to the set-top box 34 of the user terminal system 14. The contents receiver 48 decodes and converts the contents to the NTSC audio-visual signal 56 and outputs the signal to the monitor 36 at the time T30 (SIGNAL 88). The monitor 36 displays the audio-visual signal 56 in the form of pictures and voices.

The system operates as described above, in other words, the authentication processing is performed on the side of delivery server 12, instead on the set-top box 34 side. It is therefore possible to reduce the required processing of the set-top box 34. In this case, the authentication processing may be achieved unitarily at the delivery server 12 installed at the center.

The entire disclosure of Japanese patent application No. 2005-287776 filed on Sep. 30, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method of delivering contents, comprising:
a first step of preparing a content delivery server for delivering stored contents to a user terminal system provided with an access function to the content server;
a second step of reading out stored information from a storage medium at the user terminal system;
a third step of monitoring a status of the user terminal system according to a detection of the information read out, and determining whether or not the status is an operating status in which a picture is displayable;
a fourth step of temporarily storing the information read out in the operating status of the user terminal system;
a fifth step of reading out and authenticating key information included in the stored information;
a sixth step of reading out and authenticating time limit information included in the stored information;
a seventh step of generating, if results from authentication in said fifth and sixth steps are true, a packet to which delivery request information indicating the contents included in the stored information is added and then sending the generated packet to the delivery server;
an eighth step of delivering the contents to the user terminal system which has sent the packet from the delivery server; and
a ninth step of decoding the received contents into a signal based on a specific standard at the user terminal system.

2. The method in accordance with claim 1, wherein said sixth step and said seventh step use either protocol of the HTTP (Hyper Text Transfer Protocol) and the RTSP (Real Time Streaming Protocol).

3. A method of delivering contents, comprising:
a first step of preparing a content delivery server for delivering stored contents to a user terminal system provided with an access function to the content server;
a second step of reading out stored information from a storage medium at the user terminal system;
a third step of monitoring a status of the user terminal system according to a detection of the information read out, and determining whether or not the status is an operating status in which a picture is displayable;
a fourth step of temporarily storing the information read out in the operating status of the user terminal system;
a fifth step of reading out key information and time limit information both included in the stored information to form identification information including the key information and the time limit information read out, generating a packet to which the identification information is added, and sending the generated packet to the delivery server;
a sixth step of authenticating the identification information at the delivery server;
a seventh step of sending determination information based on a result from authentication at the delivery server to the user terminal system which has sent the packet;
an eighth step of generating, when the determination information is right information, a packet to which delivery request information indicating the contents included in the stored information is added at the user terminal system, and sending the generated packet to the delivery server,
a ninth step of searching for the contents corresponding to the delivery request information at the delivery server;
a tenth step of delivering the contents from the delivery server to the user terminal system which has sent the packet; and
an eleventh step of decoding the received contents into a signal based on a specific standard and outputting the decoded signal at the user terminal system.

4. The method in accordance with claim 3, wherein said forth step and said seventh step use the HTTP (Hyper Text Transfer Protocol) on the SSL (Secure Socket Layer) for the packet to be sent, and said seventh step and said tenth step use either protocol of the HTTP and the RTSP (Real Time Streaming Protocol).

5. A content delivery system wherein a delivery server delivers stored contents to a user terminal system provided with an access function to the delivery server, said user terminal system comprising:
a set-top box for determining information on whether or not a delivery of the contents is possible to be sent from said delivery server to notify said delivery server of a result of determination on whether or not the delivery is possible, and decoding received contents to output the decoded contents;
a card reader for reading out information stored in a card-type storage medium and supplying the information to said set-top box; and
a monitor for displaying the contents;
said set-top box comprising:
a reader interface circuit for reading out information from said card reader;
a memory for temporarily storing the information read out;
an authenticator for authenticating an identification key permitting the delivery and delivery time limit information both included in the stored information, and generating an enable signal according to a authentication result indicating authenticity;
a transmitter operative in response to the enable signal for sending contents information included in the information read out as delivery request information to said delivery server; and
a receiver for receiving the contents supplied from said delivery server and decoding the contents,
said delivery server receiving the delivery request information to search for the contents corresponding to the delivery request information, and delivering the contents to said user terminal system which has sent the delivery request information.

6. The content delivery system in accordance with claim 5, wherein said transmitter uses either protocol of the HTTP (Hyper Text Transfer Protocol) and the RTSP (Real Time Streaming Protocol).

7. A content delivery system wherein a delivery server delivers stored contents to a user terminal system provided with an access function to the delivery server, said user terminal system comprising:
a set-top box for determining, before receiving the contents, information on whether or not a delivery of the contents is possible to be sent from said delivery server, communicating with said delivery server when the delivery is possible, and decoding received contents to output the decoded contents;
a card reader for reading out information stored in a card-type storage medium and supplying the information to said set-top box; and
a monitor for displaying the contents,
said set-top box comprising:
a reader interface circuit for reading out information from said card reader;
a memory for temporarily storing the information read out;
a first transmitter for packetizing the stored information as identification information to send the identification information to said delivery server;
a second transmitter for sending contents information included in the information read out as delivery request information to said delivery server when the information sent from said delivery server on whether or not the delivery of the contents is possible shows that delivery processing can be continued; and
a receiver for receiving the contents supplied from said delivery server and decoding the received contents, said delivery server receiving the identification information, determining whether or not the delivery of the contents is possible based on the identification information, and sending a result from determination as the information on whether or not the delivery is possible to said user terminal system which has sent the identification information, receiving the delivery request information, searching for the contents corresponding to the delivery request information, and delivering the contents to said user terminal system which has sent the identification information.

8. The content delivery system in accordance with claim 7, wherein said first transmitter uses the HTTP (Hyper Text Transfer Protocol) on the SSL (Secure Socket Layer) for the packet to be sent, and said second transmitter unit uses either protocol of the HTTP and the RTSP (Real Time Streaming Protocol).
